(19) United States
(12) Patent Application Publication
(10) Pub. No.: US 2025/0074389 A1
(43) Pub. Date: Mar. 6, 2025

(54) APPARATUS AND METHOD FOR CONTROLLING STEERING AND SPEED OF EACH WHEEL OF VEHICLE USING TURNING CENTER

(71) Applicants: Hyundai Motor Company, Seoul (KR); Kia Corporation, Seoul (KR)

(72) Inventor: Jang Shin Kim, Gunpo-si (KR)

(21) Appl. No.: 18/411,655

(22) Filed: Jan. 12, 2024

(30) Foreign Application Priority Data
Aug. 29, 2023 (KR) 10-2023-0113991

(51) Int. Cl. B60W 10/20; B60W 10/22

(52) U.S. Cl. CPC B60W 10/20; B60W 10/22; B60W 2030/043; B60W 2050/0005; B60W 2050/0026; B60W 2050/0031; B60W 2540/18; B60W 2710/207

(57) ABSTRACT

An embodiment method of controlling steering and a speed of each wheel of a vehicle based on a center of turning includes calculating a center point of turning of the vehicle based on driving information of the vehicle, calculating a radius of turning of the vehicle, a steering angle of each wheel, and a radius of turning of each wheel based on the center point of turning, calculating a power frequency of each wheel based on the radius of turning and a required speed, and outputting the steering angle of each wheel into a corresponding steering device and applying power at the power frequency of each wheel to a corresponding in-wheel motor during a period of time during which the vehicle is moved based on the steering angle of each wheel and the power frequency of each wheel.

### CROSS-REFERENCE TO RELATED APPLICATIONS

This application claims the benefit of Korean Patent Application Number 10-2023-0113991, filed on Aug. 29, 2023, which application is hereby incorporated herein by reference.

### TECHNICAL FIELD

The present disclosure relates to an apparatus and a method for controlling the steering and the speed of each wheel of a vehicle based on the center of turning.

### BACKGROUND

The description in this section merely provides background information related to embodiments of the present disclosure and does not necessarily constitute the related art.

A steering device of a vehicle is a system for steering of the vehicle, and a rear wheel steering (RWS) system is a system for improving maneuverability of a vehicle at low speeds and stability in driving of the vehicle at high speeds by adjusting steering angles of rear wheels based on steering angles of the vehicle's front wheels and the speed of the vehicle.

An in-wheel motor refers to an electric motor mounted on a wheel to directly drive wheels of a vehicle. In the case of conventional vehicles, a central motor or an engine is installed in the engine room of the vehicle so that the engine's power is delivered to the wheels through various shafts and gear devices. In contrast, in the case of an in-wheel motor system, a driving force of a motor is delivered directly to wheels of a vehicle, improving the efficiency of power use, and it is possible to reduce the weight of the vehicle by eliminating a large driving motor installed in the engine room of the vehicle and use the space in the engine room for other purposes.

Recently, a system capable of independently controlling steering and driving of each of four wheels of a vehicle has been developed. However, when simply integrating the conventional rear-wheel steering system and the in-wheel motor system, there is a problem in that a vehicle cannot be controlled stably due to the complex structure and errors in the data sensed by various sensors.

Therefore, there is a need for a method of stably controlling steering and acceleration/deceleration of individual wheels with a simple structure.

### SUMMARY

Embodiments of the present disclosure provide an apparatus and a method for calculating the center of turning of a vehicle based on driving information and controlling the steering and the speed of individual wheels based on the center of turning.

Other embodiments of the present disclosure provide a method of adjusting the height of a vehicle's suspension based on the center of turning of the vehicle.

The embodiments of the present disclosure are not limited to those mentioned above, and other embodiments not mentioned herein will be clearly understood by those skilled in the art from the following description.

One embodiment of the present disclosure provides a method of controlling the steering and the speed of each wheel of a vehicle based on the center of turning, including calculating the center point of turning of the vehicle based on driving information of the vehicle, calculating a radius of turning of the vehicle, a steering angle of each wheel, and a radius of turning of each wheel, based on the center point of turning, calculating a power frequency of each wheel based on the radius of turning and a required speed, and outputting the steering angle of each wheel into a corresponding steering device and applying power at the power frequency of each wheel to a corresponding in-wheel motor during a period of time during which a vehicle is moved based on the steering angle of each wheel and the power frequency of each wheel.

The driving information of the vehicle includes a driving trajectory to be followed by the vehicle or an angle of a steering wheel input by a user.

Another embodiment of the present disclosure provides an apparatus for controlling the steering and the speed of each wheel of a vehicle based on the center of turning, including an in-wheel motor mounted on each wheel of the vehicle, a steering device for performing steering of each wheel of the vehicle, and a controller for controlling a steering angle and the speed of each wheel of the vehicle, wherein the controller includes a turning center calculation unit configured to calculate the center point of turning of the vehicle based on driving information of the vehicle, a steering angle calculation unit configured to calculate a radius of turning of the vehicle, the steering angle of each wheel, and a radius of turning of each wheel, based on the center point of turning, a power frequency calculation unit configured to calculate a power frequency of each wheel based on the radius of turning and a required speed of each wheel, and an output unit configured to output the steering angle of each wheel into a corresponding steering device and apply power at the power frequency of each wheel to a corresponding in-wheel motor during a period of time during which the vehicle is moved based on the steering angle of each wheel and the power frequency of each wheel.

According to the embodiments of the present disclosure, it may be possible to simplify the structure for controlling the steering and the speed of individual wheels.

According to the embodiments of the present disclosure, it may be possible to improve stability and convenience in driving of a vehicle.

### BRIEF DESCRIPTION OF THE DRAWINGS

FIG. 1 is an exemplary diagram of a vehicle having some of the components of an apparatus for controlling the steering and the speed of each wheel of the vehicle based on the center of turning according to an embodiment of the present disclosure.

FIGS. 2A-2C are diagrams illustrating how the center of turning of a vehicle varies depending on how each wheel is steered.

FIG. 3 is an exemplary diagram of a process of calculating the center of turning of a vehicle based on steering angles of front and rear wheels.

FIG. 4 is a diagram of components of the apparatus for controlling the steering and the speed of each wheel of a vehicle based on the center of turning according to an embodiment of the present disclosure.

FIGS. 5A and 5B are exemplary diagrams illustrating coordinate transformation for calculating the center of turning under the conditions for autonomous driving where a driving trajectory to be followed by a vehicle is given as a set of point coordinates according to an embodiment of the present disclosure.

FIG. 6 is an exemplary diagram illustrating a process of calculating the center of turning under the conditions for autonomous driving where a driving trajectory to be followed by a vehicle is given as a set of point coordinates according to an embodiment of the present disclosure.

FIG. 7 is an exemplary diagram illustrating a process of calculating the center of turning when a user steers a vehicle himself/herself with a steering wheel in which only steering of front wheels is possible according to another embodiment of the present disclosure.

FIG. 8 is an exemplary diagram illustrating a process of calculating a steering angle based on the center of turning of a vehicle and location of each wheel according to an embodiment of the present disclosure.

FIG. 9 is an exemplary diagram illustrating a process of calculating the adjusted height of a vehicle's suspension based on a radius of turning and a required speed of the vehicle according to an embodiment of the present disclosure.

FIG. 10 is a flowchart of a control process for each scenario according to an embodiment of the present disclosure.

FIG. 11 is a flowchart of a process of controlling the steering and the speed of each wheel of a vehicle based on the center of turning according to an embodiment of the present disclosure.

### DETAILED DESCRIPTION OF ILLUSTRATIVE EMBODIMENTS

Hereinafter, some embodiments of the present disclosure will be described in detail with reference to the accompanying illustrative drawings. In the following description, like reference numerals preferably designate like elements, although the elements are shown in different drawings. Further, in the following description of some embodiments, a detailed description of related known components and functions when considered to obscure the subject of embodiments of the present disclosure will be omitted for the purpose of clarity and for brevity.

Various ordinal numbers or alpha codes such as first, second, i), ii), a), b), etc. are prefixed solely to differentiate one component from the other but not to imply or suggest the substances, order, or sequence of the components. Throughout this specification, when a part “includes” or “comprises” a component, the part is meant to further include other components, not to exclude thereof unless specifically stated to the contrary. The terms such as “unit,” “module,” and the like refer to one or more units for processing at least one function or operation, which may be implemented by hardware, software, or a combination thereof.

The description of embodiments of the present disclosure to be presented below in conjunction with the accompanying drawings is intended to describe exemplary embodiments of the present disclosure and is not intended to represent the only embodiments in which the technical idea of the embodiments of the present disclosure may be practiced.

The term “center of turning” in the present disclosure refers to a central point of turning outside a vehicle and can be used interchangeably with the term “center of rotation.” The term “radius of turning” can be used interchangeably with the term “radius of rotation.”

In the present disclosure, a steering angle for each wheel has a negative value when a wheel is steered to the right based on the axis in the direction in which the vehicle is traveling, and a steering angle for each wheel has a positive value when a wheel is steered to the left based on the axis in the direction in which the vehicle is traveling.

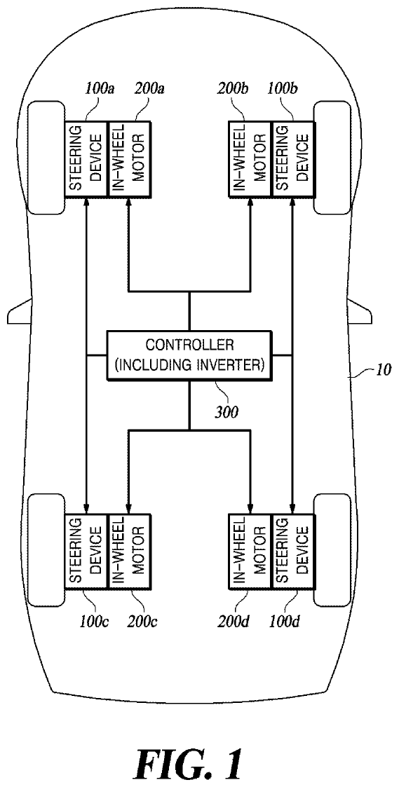

FIG. 1 is an exemplary diagram of a vehicle having some of the components of an apparatus for controlling the steering and the speed of each wheel of the vehicle based on the center of turning according to an embodiment of the present disclosure.

Referring to FIG. 1, a vehicle 10 according to an embodiment of the present disclosure may include steering devices 100a, 100b, 100c, and 100d, in-wheel motors 200a, 200b, 200c, and 200d, and a controller 300. The vehicle 10 may further include various sensors (not shown) and a device for controlling suspensions 400 to obtain driving information.

The steering devices 100a, 100b, 100c, and 100d may perform steering by receiving information on a steering angle for each wheel from the controller 300.

The in-wheel motors 200a, 200b, 200c, and 200d may be mounted inside each wheel of the vehicle 10, respectively, and may accelerate/decelerate by receiving AC power at a power frequency of each wheel from the controller 300.

The controller 300 may steer each wheel based on an angle of turning of each wheel calculated based on the center of turning of an expected driving trajectory given during autonomous parking or driving. The controller 300 may control the speed of each wheel by controlling a power frequency of each in-wheel motor based on the speed of each wheel extracted based on a tracking speed and the center of turning.

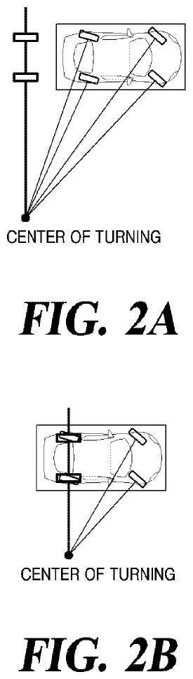

With reference to FIGS. 2A, 2B, and 2C, it will be described how the center of turning of a vehicle varies depending on how each wheel is steered. FIG. 2A shows the center of turning of a vehicle having a rear-wheel steering system when steering directions of the rear wheels and steering directions of the front wheels are the same, that is, when they are in the same phase. The front and rear wheels may be controlled in phase with each other at high speeds, thereby improving driving stability. FIG. 2B shows the center of turning of a vehicle not having a rear-wheel steering system, that is, a vehicle where only steering of front wheels is possible. FIG. 2C shows the center of turning of a vehicle having a rear-wheel steering system when steering angles of the rear wheels and steering angles of the front wheels are opposite, that is, out of phase. The front and rear wheels may be controlled out of phase with each other at low speeds so that a radius of turning of the vehicle may be reduced, thereby enhancing maneuverability.

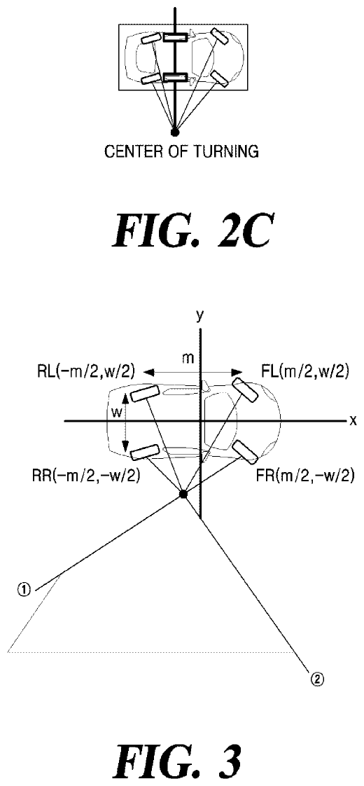

With reference to FIG. 3, an example of a process of calculating the center of turning of a vehicle based on steering angles of front and rear wheels will be described. With the center of a vehicle as a reference point, a coordinate where the x-axis is in the longitudinal direction of the vehicle and the y-axis is in the transverse direction of the vehicle is assumed.

Referring to FIG. 3, the front left (FL) wheel of the vehicle has a coordinate of (m/2, w/2), the front right (FR) wheel has a coordinate of (m/2, −w/2), the rear left (RL) wheel has a coordinate of (−m/2, w/2), and the rear right (RR) wheel has a coordinate of (−m/2, −w/2). Here, “m” denotes a wheel base of the vehicle, and “w” denotes a tread of the vehicle. The hatched trapezoid represents an area where the center of turning of the vehicle may exist based on steering angles of the front/rear wheels when the vehicle turns to the right.

When a steering angle of the FR wheel is given as α and a steering angle of the RR wheel is given as β, the center of turning of the vehicle may be at the intersection point of straight lines \textcircled{1} and \textcircled{2}. Here, the equation of each of straight lines \textcircled{1} and \textcircled{2} may be as shown in Equation 1, and the x and y coordinates of the intersection point of the two straight lines may be calculated as shown in Equation 2.

$$line y = tan ( \frac{π}{2} + α ) x - tan ( \frac{π}{2} + α ) * \frac{m}{2} - \frac{w}{2} , \qquad Equation 1$$

$$line y = tan ( \frac{π}{2} + β ) x - tan ( \frac{π}{2} + β ) * \frac{m}{2} - \frac{w}{2}$$

$$x = \frac{m}{2} * \frac{tan ( \frac{π}{2} + α ) + tan ( \frac{π}{2} + β )}{tan ( \frac{π}{2} + α ) - tan ( \frac{π}{2} + β )} , \qquad Equation 2$$

$$y = m * \frac{tan ( \frac{π}{2} + α ) + tan ( \frac{π}{2} + β )}{tan ( \frac{π}{2} + α ) - tan ( \frac{π}{2} + β )} - \frac{w}{2}$$

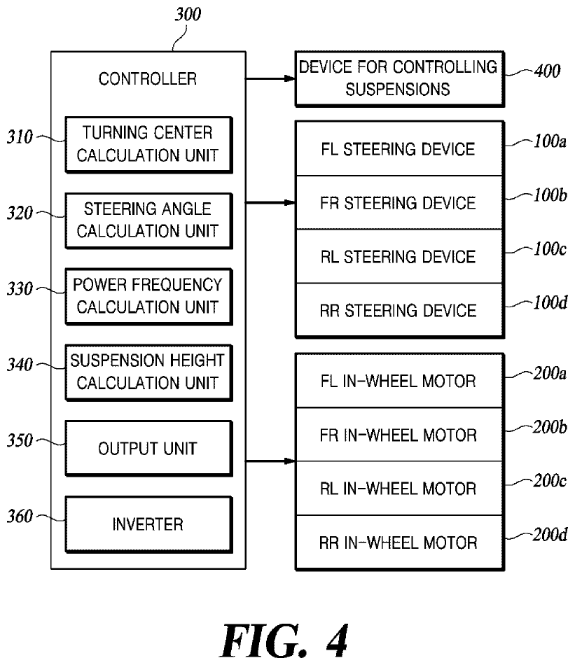

FIG. 4 is a diagram of components of the apparatus for controlling the steering and the speed of each wheel of a vehicle based on the center of turning according to an embodiment of the present disclosure.

Referring to FIG. 4, the apparatus for controlling the steering and the speed of each wheel of a vehicle based on the center of turning according to an embodiment of the present disclosure (hereinafter, referred to as an “apparatus for controlling the steering and the speed of each wheel”) may control the steering and the speed of each wheel based on the center of turning of a vehicle and may control the process of adjusting the height of the vehicle's suspension. To this end, the apparatus for controlling the steering and the speed of each wheel may include the steering devices 100a, 100b, 100c, and 100d, the in-wheel motors 200a, 200b, 200c, and 200d, and the controller 300. The apparatus for controlling the steering and the speed of each wheel may further include the device for controlling suspensions 400.

Components of the apparatus for controlling the steering and the speed of each wheel may transmit or receive signals or data using various communication protocols inside a vehicle. Here, the communication protocols may include at least one of a controller area network (CAN), CAN with Flexible Data-Rate (CAN FD), local interconnect network (LIN), FlexRay, and Ethernet.

The steering devices 100a, 100b, 100c, and 100d and the in-wheel motors 200a, 200b, 200c, and 200d have been described above.

Using the center point of turning of a vehicle calculated based on information on driving of the vehicle, the controller 300 may determine a steering angle of each wheel and output it to the steering device and may determine a power frequency of each wheel and apply it to the in-wheel motor. The controller 300 may determine the height of a vehicle's suspension and output it to the device for controlling suspensions 400. To this end, the controller 300 may include all or some of a turning center calculation unit 310, a steering angle calculation unit 320, a power frequency calculation unit 330, a suspension height calculation unit 340, an output unit 350, and an inverter 360.

The controller 300 may be placed inside a vehicle and may be an electronic control unit (ECU). The controller 300 may include a hardware processor and a memory for storing commands, a look-up table (LUT), etc. for executing the controller 300, but it is not limited thereto. The controller 300 may include all components for overall control of the apparatus for controlling the steering and the speed of each wheel.

The turning center calculation unit 310 may calculate the center of turning of a vehicle based on information about the vehicle's driving. Here, information about the vehicle's driving may include a driving trajectory to be followed by the vehicle, an angle of a steering wheel input by a user, the speed of the vehicle, etc.

The process of calculating the center of turning under the conditions for autonomous driving where a driving trajectory to be followed by a vehicle is given as a set of point coordinates according to an embodiment of the present disclosure is as follows. Point coordinates of a driving trajectory may be managed as the world coordinate system.

The turning center calculation unit 310 may calculate the center of turning based on data about a current location of a vehicle (current location and current direction) and data about a target location of the vehicle (target location and target direction).

The turning center calculation unit 310 may set a local coordinate system using a current location of a vehicle as a reference point. That is, the local coordinate system may be set with the center of the vehicle at the current location as the reference point and the x-axis in the longitudinal direction of the vehicle.

The turning center calculation unit 310 may extract data about a target position to which a vehicle will move from a given driving trajectory. Specifically, the turning center calculation unit 310 may select two points P1 (px1, py1) and P2 (px2, py2) from the driving trajectory and convert them into a local coordinate system. The two points may be selected based on specifications of a vehicle and/or the speed of the vehicle. When there are many point coordinates included in a driving trajectory, two points (P1 and P2) may be selected by sampling the point coordinates periodically or appropriately to reduce the amount of calculation.

The center P (px, py) of the two points and a slope α of a straight line passing through the two points may be calculated using Equation 3 below. The center P may represent a target location, and the slope α may represent a target direction in which a vehicle is traveling. The equation of a straight line passing through two points (P1 and P2) may be derived based on the center P and the slope α.

$$P ( px , py ) = ( ( px 1 + px 2 ) / 2 , ( py 1 + py 2 ) / 2 ) \qquad Equation 3$$

$$a = ( py 2 - py 1 ) / ( px 2 - px 1 )$$

When a vehicle moves from its current location to its target location, a new local coordinate system may be set with the center of the vehicle at the target location as a reference point and the x-axis in the longitudinal direction of the vehicle, and the above-mentioned process may be repeated.

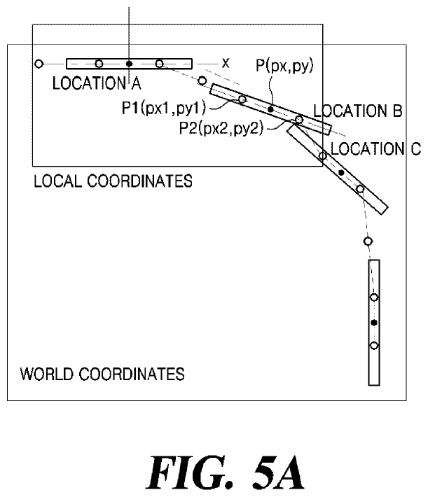

FIG. 5A shows setting a local coordinate system based on a current location (location A) and coordinate transformation of two points (P1 and P2) corresponding to a target location (location B). FIG. 5B shows setting a new local coordinate system based on the location B when a vehicle moves from the location A to the location B and coordinate transformation of two points (P3 and P4) corresponding to a next target location (location C).

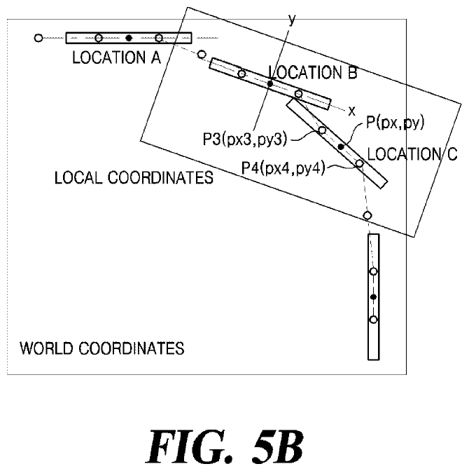

The turning center calculation unit 310 may calculate the center of turning of a vehicle based on a current location data and a target location data of the vehicle. The process of calculating the center of turning will be described in detail with reference to FIG. 6.

First, points (d, 0) and (pdx, pdy) that are the same distance (d) away from the center of a vehicle in a direction in which the vehicle is traveling or a longitudinal direction at each of a current location (location A) and a target location (location B) may be selected, and straight lines \textcircled{a} and \textcircled{b} starting from each of the points may be drawn perpendicular to the direction in which the vehicle is traveling at each point.

When the measured lengths from a point (s, t) where the two straight lines \textcircled{a} and \textcircled{b} meet to each of the two points (d, 0) and (pdx, pdy) have the same value, the point (s, t) may be regarded as the center of turning of the vehicle.

The slope of the straight line \textcircled{a} may be obtained based on P1 (px1, py1) and P2 (px2, py2), and the equation of the straight line may be obtained based on the (pdx, pdy) coordinates. The slope of the straight line \textcircled{a} and the angle between the two straight lines \textcircled{a} and \textcircled{b}, that is, the angle of turning of the vehicle, may be calculated as shown in Equation 4 below.

$$a = tan ( π / 2 + θ ) , θ = {tan}^{- 1} ( ( py 2 - py 1 ) / ( px 2 - px 1 ) ) \qquad Equation 4$$

In Equation 4, α denotes the slope of the straight line \textcircled{a}, and θ denotes the angle between the two straight lines \textcircled{a} and \textcircled{b}, that is, the angle of turning of the vehicle.

Because the equation of the straight line \textcircled{a} may be as shown in Equation 5 and the equation of the straight line \textcircled{b} may be as shown Equation 6, the intersection point (s, t) of the two straight lines \textcircled{a} and \textcircled{b} may be obtained as shown in Equation 7.

$$y = a * x + pdy - a * pdx \qquad Equation 5$$

$$x = d \qquad Equation 6$$

$$( s , t ) = ( d , a * d + pdy - a * pdx ) \qquad Equation 7$$

Whether the lengths from the intersection point (s, t) to each point of the two points (d, 0) and (pdx, pdy) have the same value may be determined by solving Equation 8 to determine the optimal solution of d in the range δ≤d≤σ (δ<0, σ>0). Here, δ and σ may be limited by a maximum steering angle of a tire and specifications of a vehicle.

$${d}^{2} - 2 d ( pdx + a * pdy ) + {pdx}^{2} - {pdy}^{2} + 2 a - pdx * pdy = 0 \qquad Equation 8$$

The center of turning of a vehicle may be calculated by applying the obtained value d into Equation 7.

According to another embodiment of the present disclosure, the process of calculating the center of turning when a user steers himself/herself with a steering wheel is as follows.

In the case of a vehicle having a rear-wheel steering system, the center of turning of the vehicle and the one-step vehicle movement time t, which are tuned based on an angle of a steering wheel input by a user, the speed of the vehicle, etc., may be stored in advance in a look-up table (LUT) to be managed. Here, the one-step vehicle movement time t refers to a period of time during which a vehicle is moved based on a steering angle and a power frequency of each wheel. Therefore, the center point of turning corresponding to the angle of the steering wheel input by the user and the speed of the vehicle may be calculated based on the pre-stored look-up table.

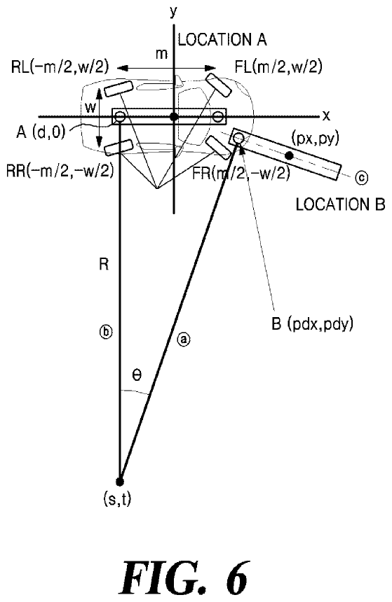

In the case of a vehicle not having a rear-wheel steering system, that is, a vehicle in which only steering of front wheels is possible, the one-step vehicle movement time t, which is tuned based on an angle of a steering wheel input by a user, the speed of the vehicle, etc., may be stored in advance in a look-up table (LUT) to be managed. Here, the one-step vehicle movement time t refers to a period of time during which a vehicle is moved based on a steering angle and a power frequency of each wheel. In this case, as described above with reference to FIG. 2B, the center of turning of the vehicle may be on the axis of the rear wheels. The center of turning of a vehicle may be obtained as shown in FIG. 7 and Equation 9.

$$line : y = a * x - a * \frac{m}{2} , a = tan ( k τ + \frac{π}{2} ) \qquad Equation 9$$

$$line : x = - \frac{m}{2}$$

$$center point of turning = ( - \frac{m}{2} , - a * m )$$

In Equation 9, k denotes a proportionality constant, t denotes an angle of a steering wheel input by a user, and m denotes a wheelbase.

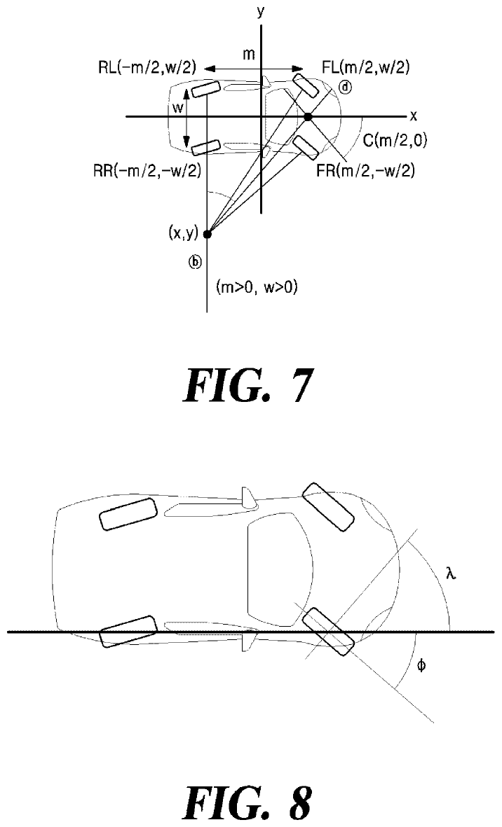

The steering angle calculation unit 320 may calculate a steering angle of each wheel based on the center point of turning of a vehicle. In addition, the steering angle calculation unit 320 may calculate a radius of turning of a vehicle and a radius of turning of each wheel based on the center point of turning of the vehicle. The process of calculating a steering angle will be described with reference to FIG. 8.

A steering angle and a radius of turning of each wheel may be calculated based on the center of turning of a vehicle and the position of each wheel.

A steering angle of each wheel may be obtained as shown in Equation 10.

$${φ}_{tire} = λ - \frac{π}{2} , λ = {tan}^{- 1} ( ( {y}^{′} - t ) / ( {x}^{′} - s ) ) \qquad Equation 10$$

In Equation 10, φₜᵢᵣₑ denotes a steering angle of each wheel, (x′, y′) denote position coordinates of each wheel, and (s, t) denote coordinates of the center of turning of a vehicle.

A radius of turning of a vehicle R_{vehicle} may be obtained as shown in Equation 11.

$${R}_{vehicle} = \sqrt{{s}^{2} + {t}^{2}} \qquad Equation 11$$

A radius of turning of each wheel Rₜᵢᵣₑ may be obtained as shown in Equation 12.

$${R}_{tire} = \sqrt{{( {y}^{′} - y )}^{2} + {( {x}^{′} - x )}^{2}} \qquad Equation 12$$

Meanwhile, the range of choices for P1 (px1, py1) and P2 (px2, py2) is limited by a maximum steering angle of each wheel and specifications of a vehicle. Therefore, the center point of turning of the vehicle, a radius of turning of the vehicle, a steering angle of each wheel, and a radius of turning of each wheel, corresponding to the selectable points P1 and P2 may be calculated in advance using Equations 3 to 11 to save data thereon in a look-up table (LUT).

The power frequency calculation unit 330 may calculate a power frequency of each wheel based on a radius of turning of each wheel and a required speed of each wheel. Here, the required speed refers to a minimum value of a limit speed or a speed set by a user.

First, the limit speed refers to the maximum speed at which no rollover occurs based on a radius of turning of a vehicle. When a vehicle turns, a rollover may occur if the sum of the moment due to centrifugal force and the moment due to gravity is less than 0. Therefore, the limit speed based on a radius of turning of a vehicle obtained by the steering angle calculation unit 320 may be calculated using Equation 13.

$$\sum = Z * m * \frac{{v}^{2}}{{R}_{vehicle}} - \frac{w}{2} * m * g = 0 , {V}_{Rollover} = \sqrt{\frac{w * g * {R}_{vehicle}}{2 Z}} \qquad Equation 13$$

In Equation 13, Σ denotes the sum of moments, Z denotes the height from the ground to the center of a vehicle, w denotes the tread of the vehicle, m denotes the weight of the vehicle, g denotes the gravitational acceleration, R_{vehicle} denotes a radius of turning of the vehicle, and V_{Rollover} denotes a limit speed at which the vehicle does not roll over.

An angular velocity of each wheel may be equal to an angular velocity (ω) of a vehicle. The speed of each wheel Vₜᵢᵣₑ may be proportional to a radius of turning of each wheel Rₜᵢᵣₑ. In other words, the speed of each wheel may be determined by a radius of turning of each wheel and the angular speed of the vehicle, as shown in Equation 14.

$${V}_{tire} = {R}_{tire} * ω , ω = \frac{V}{{R}_{vehicle}} \qquad Equation 14$$

In Equation 14, V denotes a required speed.

A power frequency of each wheel fₜᵢᵣₑ may be obtained from a radius of a tire rₜᵢᵣₑ and the speed of each wheel Vₜᵢᵣₑ as shown in Equation 15.

$${f}_{tire} = {V}_{tire} / ( {r}_{tire} * 2 π ) , {V}_{tire} = {r}_{tire} * ω = {r}_{tire} * 2 π {f}_{tire} \qquad Equation 15$$

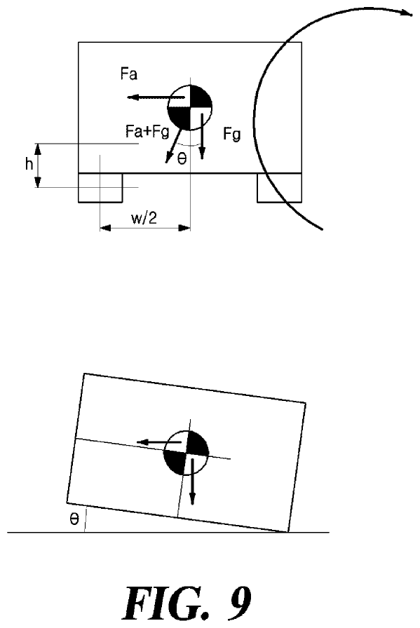

The suspension height calculation unit 340 may calculate the height of a vehicle's suspension based on a radius of turning and a required speed of the vehicle. In the case of air suspension, it may be possible to improve riding comfort by adjusting the height of the left/right suspension. The value of the force applied to a driver may correspond to the sum (Fa+Fg) of the force Fa applied by centripetal acceleration and the force Fg applied by acceleration of gravity. The driver may not feel the centripetal acceleration when the vehicle is rolled by θ as shown in FIG. 9 and Equation 16.

$$sin θ = \frac{{F}_{a}}{{F}_{a} + {F}_{g}} = \frac{\frac{{V}^{2}}{{R}_{vehicle}}}{( \frac{{V}^{2}}{{R}_{vehicle}} ) + g} = \frac{{V}^{2}}{{V}^{2} + g * {R}_{vehicle}} , sin θ = \frac{h}{w} \qquad Equation 16$$

In Equation 16, h denotes the height of a suspension of a vehicle to be adjusted, w denotes the vehicle's tread, and θ denotes the vehicle's angle that can be changed by the vehicle's air suspension.

Since a radius of turning of a vehicle, R_{vehicle}, and a required speed, V, have been calculated, the height h of the vehicle's suspension may be obtained by multiplying by an appropriate proportionality constant l, as shown in Equation 17.

$$h = \frac{w * {V}^{2}}{{V}^{2} + g * {R}_{vehicle} * l} \qquad Equation 17$$

During a period of time during which a vehicle is moved based on a steering angle of each wheel and a power frequency of each wheel (hereinafter, referred to as a “period of time for movement”), the output unit 350 may output data on a steering angle of each wheel φₜᵢᵣₑ into a corresponding steering device, apply power at a power frequency of each wheel fₜᵢᵣₑ to a corresponding in-wheel motor, and output data on the height h of a suspension into the device for controlling suspensions.

Under the conditions for autonomous driving where a driving trajectory to be followed by a vehicle is given as a set of point coordinates according to an embodiment of the present disclosure, a period of time for movement may be calculated based on an angle of turning of the vehicle, a radius of turning of the vehicle, and the speed of the vehicle. For example, a period of time t may be obtained as shown in Equation 18.

$$t = \frac{{R}_{vehicle} * θ}{V} , ( V = \frac{{R}_{vehicle} * θ}{t} ) \qquad Equation 18$$

In Equation 18, θ denotes an angle of turning of a vehicle obtained by Equation 4.

Under the conditions where a user steers himself/herself with a steering wheel according to another embodiment of the present disclosure, a period of time for movement corresponding to data input by the user on an angle of the steering wheel and the speed of the vehicle may be obtained based on a pre-stored look-up table.

The inverter 360 may convert a DC power of a battery into an AC power and supply it to an in-wheel motor. The inverter 360 may supply an AC power converted based on a power frequency of each wheel to a corresponding in-wheel motor.

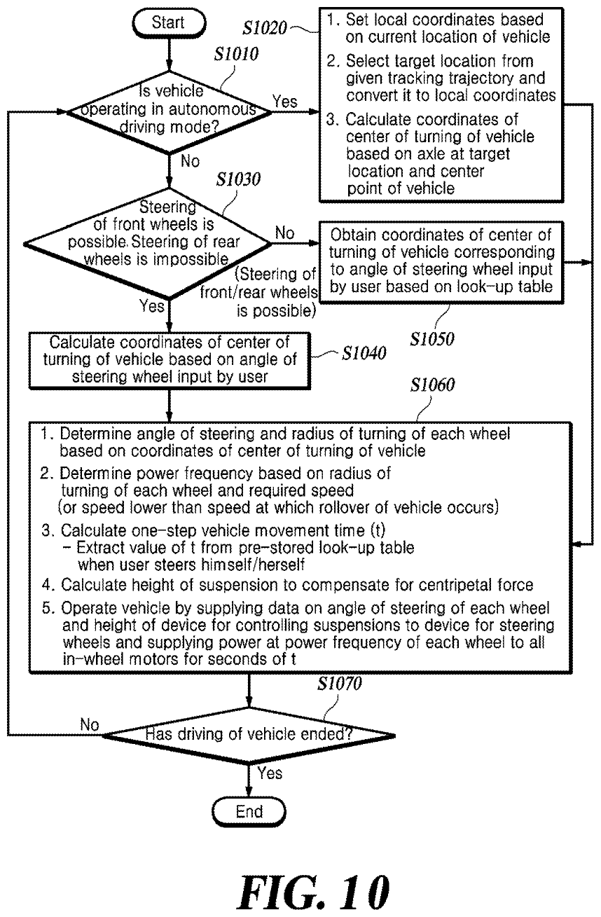

FIG. 10 is a flowchart of a control process for each scenario according to an embodiment of the present disclosure.

Referring to FIG. 10, it may be determined whether a vehicle is operating in an autonomous driving mode at S1010.

When it is determined that the vehicle is operating in the autonomous driving mode, local coordinates may be set based on a current location of the vehicle, a target location may be selected from a given tracking trajectory and converted to local coordinates, and coordinates of the center of turning of the vehicle may be calculated based on the center of the vehicle and the direction in which the vehicle is traveling at the target location at S1020.

When it is determined that the vehicle is not operating in the autonomous driving mode, it may be determined whether the vehicle has a rear-wheel steering system, i.e., whether steering of the front wheels is possible and steering of the rear wheels is impossible, at S1030.

When it is determined that the vehicle does not have a rear-wheel steering system (Yes at S1030), the coordinates of the center of turning of the vehicle may be calculated based on an angle of a steering wheel input by a user at S1040.

When it is determined that the vehicle has a rear-wheel steering system (No at S1030), the coordinates of the center of rotation of the vehicle corresponding to the angle of the steering wheel input by the user may be obtained based on a look-up table at S1050.

After the coordinates of the center of turning of the vehicle are calculated or obtained, S1060 may be performed. That is, a steering angle of each wheel and a radius of turning of each wheel may be determined based on the coordinates of the center of turning of the vehicle. A power frequency may be determined based on a radius of turning and a required speed of each wheel. A period of time for movement t may be calculated or obtained by referring to a pre-stored look-up table. The height of a suspension to compensate for centripetal force may be calculated. The vehicle may be operated by supplying data on a steering angle of each wheel and the height of the device for controlling suspensions to the device for steering wheels and supplying power at a power frequency of each wheel to all in-wheel motors for seconds of a period of time for movement t.

After it is determined whether driving of the vehicle has ended at S1070, S1010 may be performed when the vehicle is still being driven, and the entire process may be ended when driving of the vehicle has ended.

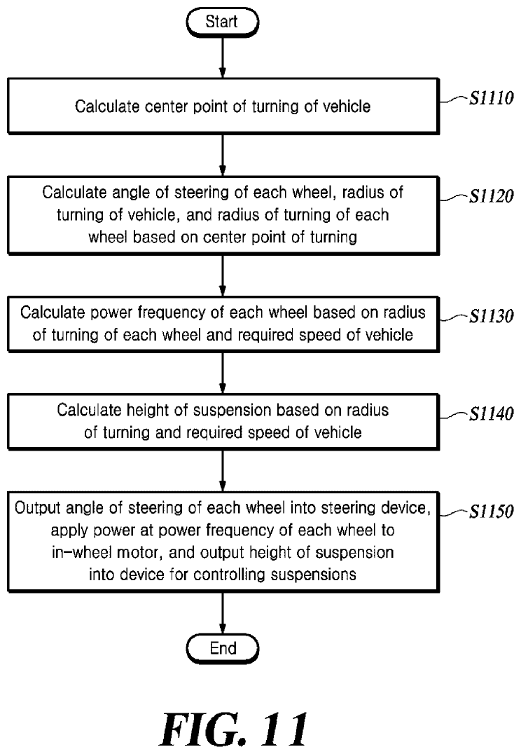

FIG. 11 is a flowchart of a process of controlling the steering and the speed of each wheel of a vehicle based on the center of turning according to an embodiment of the present disclosure.

Referring to FIG. 11, the center point of turning of the vehicle may be calculated based on information about driving of the vehicle at S1110. The information about driving of the vehicle may include a driving trajectory to be followed by the vehicle or an angle of a steering wheel input by a user.

Based on the center point of turning, a radius of turning of the vehicle, a steering angle of each wheel, and a radius of turning of each wheel may be calculated at S1120.

A power frequency of each wheel may be calculated based on a radius of turning and a required speed of each wheel at S1130.

The height of a suspension may be calculated based on a radius of turning and a required speed of the vehicle at S1140.

During a period of time for movement, a steering angle of each wheel may be output into a corresponding steering device, power at a power frequency of each wheel may be applied to a corresponding in-wheel motor, and the height of a suspension may be output into a device for controlling suspensions at S1150.

The above-described processes may be repeatedly performed while a vehicle is being driven.

Each component of the device or method according to an embodiment of the present disclosure may be implemented by hardware, software, or a combination of hardware and software. In addition, the function of each component may be implemented by software and the microprocessor may be implemented to execute the function of software corresponding to each component.

Various implementations of the systems and techniques described herein may be implemented by digital electronic circuits, integrated circuits, field programmable gate arrays (FPGAs), application specific integrated circuits (ASICs), computer hardware, firmware, software, and/or a combination thereof. These various implementations may include being implemented in one or more computer programs executable on a programmable system. The programmable system includes at least one programmable processor (which may be a special purpose processor or a general purpose processor) coupled to receive data and instructions from, and transmit data and instructions to, a storage system, at least one input device, and at least one output device. Computer programs (also known as programs, software, software applications, or code) include instructions for a programmable processor and are stored on a “computer-readable recording medium.”

The computer-readable storage medium includes all kinds of storage devices that store data readable by a computer system. The computer-readable storage medium may include a non-volatile or non-transitory medium such as a ROM, CD-ROM, magnetic tape, floppy disk, memory card, hard disk, magneto-optical disk, and storage device, and also further includes a transitory medium such as a data transmission medium. Moreover, the computer-readable storage medium may be distributed in computer systems connected through a network, and computer-readable codes may be stored and executed in a distributed manner.

In the flowcharts in the present specification, it is described that each process sequentially occurs, but this is merely an example of the technology of an embodiment of the present disclosure. In other words, a person having ordinary skill in the art to which an embodiment of the present disclosure pertains may make various modifications and variations by changing the orders described in the flowcharts in the present specification or by undergoing one or more of the processes in parallel within the essential characteristics of an embodiment of the present disclosure, so the flowcharts in this specification are not limited to a time-series order.

Although exemplary embodiments of the present disclosure have been described for illustrative purposes, those skilled in the art will appreciate that various modifications, additions, and substitutions are possible, without departing from the idea and scope of the claimed invention. Therefore, exemplary embodiments of the present disclosure have been described for the sake of brevity and clarity. The scope of the technical idea of the embodiments of the present disclosure is not limited by the illustrations. Accordingly, one of ordinary skill would understand the scope of the claimed invention is not to be limited by the above explicitly described embodiments but by the claims and equivalents thereof.

What is claimed is:

1. A method of controlling steering and a speed of each wheel of a vehicle based on a center of turning, the method comprising:
calculating a center point of turning of the vehicle based on driving information of the vehicle;
calculating a radius of turning of the vehicle, a steering angle of each wheel, and a radius of turning of each wheel based on the center point of turning;
calculating a power frequency of each wheel based on the radius of turning and a required speed; and
outputting the steering angle of each wheel into a corresponding steering device and applying power at the power frequency of each wheel to a corresponding in-wheel motor during a period of time during which the vehicle is moved based on the steering angle of each wheel and the power frequency of each wheel.

2. The method of claim 1, wherein the driving information of the vehicle includes a driving trajectory to be followed by the vehicle or an angle of a steering wheel input by a user.

3. The method of claim 2, wherein calculating the center point of turning comprises:
setting a local coordinate system using a current location of the vehicle as a reference point;
selecting a target location to which the vehicle will move from the driving trajectory and converting the target location into the local coordinate system; and
calculating the center point of turning of the vehicle based on the current location and the target location.

4. The method of claim 3, wherein the period of time during which the vehicle is moved based on the steering angle of each wheel and the power frequency of each wheel is calculated based on an angle of turning between the current location and the target location, the radius of turning of the vehicle, and a speed of the vehicle.

5. The method of claim 2, wherein, in calculating the center point of turning, the center point of turning of the vehicle is calculated based on a look-up table in which the center point of turning corresponding to the angle of the steering wheel input by the user and a speed of the vehicle is stored in advance.

6. The method of claim 5, wherein the period of time during which the vehicle is moved based on the steering angle of each wheel and the power frequency of each wheel is obtained as the period of time corresponding to the angle of the steering wheel input by the user and the speed of the vehicle based on the look-up table.

7. The method of claim 1, wherein, in calculating the radius of turning of the vehicle, the radius of turning of the vehicle is calculated based on the center point of turning and a center point of the vehicle.

8. The method of claim 1, wherein, in calculating the steering angle of each wheel and the radius of turning of each wheel, the steering angle of each wheel and the radius of turning of each wheel are calculated based on the center point of turning and a location of each wheel of the vehicle.

9. The method of claim 1, wherein the required speed is a minimum value between a limit speed at which no rollover occurs based on the radius of turning of the vehicle and a speed set by a user.

10. The method of claim 1, wherein calculating the power frequency of each wheel comprises:
calculating an angular velocity of the vehicle based on the radius of turning of the vehicle and a speed of the vehicle;
calculating the speed of each wheel based on the angular velocity of the vehicle and the radius of turning of each wheel; and
calculating the power frequency of each wheel based on the speed of each wheel and a radius of each wheel.

11. The method of claim 1, further comprising:
calculating a height of a suspension of the vehicle based on the radius of turning of the vehicle and the required speed; and
outputting the calculated height of the suspension into a corresponding device for controlling suspensions during the period of time during which the vehicle is moved.

12. An apparatus for controlling steering and a speed of each wheel of a vehicle based on a center of turning, the apparatus comprising:
an in-wheel motor mounted on each wheel of the vehicle;
a steering device for performing steering of each wheel of the vehicle; and
a controller for controlling a steering angle and the speed of each wheel of the vehicle, wherein the controller comprises:
one or more processors; and
a storage device storing a program to be executed by the one or more processors, the program including instructions for:
calculating a center point of turning of the vehicle based on driving information of the vehicle;
calculating a radius of turning of the vehicle, the steering angle of each wheel, and a radius of turning of each wheel based on the center point of turning;
calculating a power frequency of each wheel based on the radius of turning and a required speed of each wheel; and
outputting the steering angle of each wheel into the corresponding steering device and applying power at the power frequency of each wheel to the corresponding in-wheel motor during a period of time during which the vehicle is moved based on the steering angle of each wheel and the power frequency of each wheel.

13. The apparatus of claim 12, wherein the driving information of the vehicle comprises a driving trajectory to be followed by the vehicle or an angle of a steering wheel input by a user.

14. The apparatus of claim 13, wherein the program further includes instructions for setting a local coordinate system using a current location of the vehicle as a reference point, selecting a target location to which the vehicle will move from the driving trajectory, converting the target location into the local coordinate system, and calculating the center point of turning of the vehicle based on the current location and the target location.

15. The apparatus of claim 14, wherein the period of time during which the vehicle is moved based on the steering angle of each wheel and the power frequency of each wheel is calculated based on an angle of turning between the current location and the target location, the radius of turning of the vehicle, and a speed of the vehicle.

16. The apparatus of claim 13, wherein the program further includes instructions for calculating the center point of turning of the vehicle based on a look-up table in which the center point of turning corresponding to the angle of the steering wheel input by the user and a speed of the vehicle is stored in advance.

17. The apparatus of claim 16, wherein the period of time during which the vehicle is moved based on the steering angle of each wheel and the power frequency of each wheel is obtained as the period of time corresponding to the angle of the steering wheel input by the user and the speed of the vehicle based on the look-up table.

18. The apparatus of claim 12, further comprising a device for controlling suspensions for adjusting a height of the suspensions of the vehicle, wherein the program further includes instructions for calculating the height of the suspensions of the vehicle based on the radius of turning of the vehicle and the required speed and outputting the height of the suspensions of the vehicle into the device for controlling the suspensions.

19. The apparatus of claim 12, wherein the required speed is a minimum value between a limit speed at which no rollover occurs based on the radius of turning of the vehicle and a speed set by a user.

20. The apparatus of claim 12, wherein the program further includes instructions for calculating the power frequency of each wheel by:
calculating an angular velocity of the vehicle based on the radius of turning of the vehicle and a speed of the vehicle;
calculating the speed of each wheel based on the angular velocity of the vehicle and the radius of turning of each wheel; and
calculating the power frequency of each wheel based on the speed of each wheel and a radius of each wheel.
